(19) United States
(12) Patent Application Publication
(10) Pub. No.: US 2025/0374360 A1
(43) Pub. Date: Dec. 4, 2025

(54) PARAMETER SELECTION FOR CONNECTION ESTABLISHMENT FAILURE CONTROL

(71) Applicant: QUALCOMM Incorporated, San Diego, CA (US)

(72) Inventors: Jiaheng LIU, Shanghai (CN); Shanshan WANG, San Diego, CA (US); Cen CHEN, Beijing (CN); Huan XU, San Diego, CA (US); Xianwei ZHU, Beijing (CN); Jing DAI, Shanghai (CN); Yifan DU, Beijing (CN); Huichun CHEN, Beijing (CN); Xuqiang ZHANG, Beijing (CN); Shan QING, San Diego, CA (US); Yue HONG, San Diego, CA (US)

(21) Appl. No.: 18/707,862

(22) PCT Filed: Jan. 20, 2022
(86) PCT No.: PCT/CN2022/072988

§ 371 Date: May 6, 2024

(51) Int. Cl. H04W 76/18; H04W 36/00

(52) U.S. Cl. CPC H04W 76/18; H04W 36/0085

(57) ABSTRACT

In an aspect of the disclosure, a method, a computer-readable medium, and an apparatus are provided. The apparatus may be a UE or a component thereof that is configured to detect a connection establishment failure associated with a network node. The apparatus may be further configured to apply a set of preconfigured values respectively associated with a set of connection establishment failure control parameters when the connection establishment failure is detected.

### BACKGROUND

### Technical Field

The present disclosure generally relates to communication systems, and more particularly, to user equipment (UE) configured to control operations when experiencing failures to establish connections with radio access or other wireless networks.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In radio access and similar wireless networks, systems and devices may be configured with protocol stacks having multiple layers, which may include a network layer, Layer 3 (L3), or other similar layer logically situated, for example, above the physical (PHY) and/or medium access control (MAC) layers but below the application, presentation, and/or other higher layer(s). At the network layer or L3, user equipment (UE) and network nodes or entities (e.g., a base station, a remote radio head (RRH), a nodeB, eNB, gNB, and so forth) providing connectivity to such UEs may communicate network packets. Particularly, network nodes may route and forward packets to destination UEs.

Various radio access technologies, such as Long Term Evolution (LTE) and 5G New Radio (NR), utilize a radio resource control (RRC) protocol at L3. As network nodes may provide connectivity to UEs, the RRC protocol may provide functionality for connection establishment, transmission of system information, and so forth. For example, a UE may connect with a radio access network (RAN) through an RRC Connection Establishment procedure. Such an RRC Connection Establishment procedure may be implemented as a three-way handshake.

In some implementations of an RRC Connection Establishment procedure, the UE may select (or reselect) a cell provided by a network node and transmit an RRC Connection Request message, which may be the first message in the three-way handshake procedure. In response, the UE expects an RRC Connection Setup message, which may allocate some radio resources to the UE, and the UE may then close the three-way handshake procedure by transmitting an RRC Connection Setup Complete message.

However, a UE may not necessarily receive an RRC Connection Setup message in response to an RRC Connection Request message. Illustratively, the selected cell may have reached a threshold number of connections, the UE may be prohibited from connecting to the selected cell, interference proximate to the UE may impede the message decoding process at the UE, or another factor(s) that ultimately prevents the UE from successfully receiving the RRC Connection Setup message from a network node.

Thus, the UE may be configured to reattempt RRC Connection Establishment. In some implementations, the UE may include a timer that is triggered in association with transmission of the RRC Connection Request message. If the timer elapses and the UE has still not successfully received the RRC Connection Request message, then the UE may determine that RRC Connection Establishment should be retried and the UE may transmit another RRC Connection Request message to the network node.

In certain instances, however, the UE may never receive an RRC Connection Setup message in response to an RRC Connection Request message. For example, the network node may not provide connectivity for a service that the UE is requesting or the UE may be otherwise unsuitable to connect through the selected cell. Theoretically then, a UE could become stuck in an infinite loop of transmitting RRC Connection Request messages to a selected cell from which the UE would never receive a responsive RRC Connection Setup message. That scenario and other similar scenarios may be avoided by enforcing a threshold number of attempts of an RRC Connection Establishment by a UE. The threshold and various other parameters related to control of the RRC Connection Establishment failure may be signaled to a UE from a network work via an information block, such as a system information block (SIB).

Even with those safeguards to reduce the likelihood of spreading, the UE may remain vulnerable to the above-mentioned looping or other inefficiencies. Illustratively, a UE may fail to receive network-configured values for some or all of the parameters related to control of an RRC Connection Establishment procedure attempted with a target cell. As a result, the UE may camp on the target cell and repeatedly attempt RRC Connection Reestablishment without (re) selecting a different target cell.

In view of the foregoing, there exists a need for mechanisms preventing a UE from repeatedly (re)selecting to one cell (or a small number of cells) after repeated RRC Connection Establishment failures. The present disclosure provides various techniques and solutions that may enable a UE to (re)select to a suitable cell through which the UE may connect, for example, after the UE experiences one or multiple RRC Connection Establishment failures or other similar connection (re)establishment issues.

In an aspect of the disclosure, a method, a computer-readable medium, and an apparatus are provided. The apparatus may be a UE or a component thereof that is configured to detect a connection establishment failure associated with a network node. The apparatus may be further configured to apply a set of preconfigured values respectively associated with a set of connection establishment failure control parameters when the connection establishment failure is detected.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a network node and user equipment (UE) in an access network.

FIG. 4 is a call flow diagram illustrating example operations by a UE for recovery from failure of at least one connection establishment procedure with a network node.

FIG. 5 is a block diagram illustrating an example flow of operations over conceptual protocol stacks of a UE that supports recovery from connection establishment failure using a temporary offset.

FIG. 6 is a flowchart illustrating an example of a method of recovering from failure of at least one connection establishment procedure.

FIG. 7 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

In radio access and similar wireless networks, systems and devices may be configured with protocol stacks having multiple layers, which may include a network layer, Layer 3 (L3), or other layer that is logically similarly situated with respect to a protocol stack—e.g., above at least a physical (PHY) layer but below at least an application layer. At the network layer or L3, user equipment (UE) and network nodes (e.g., base station, remote radio head (RRH), nodeB, eNB, gNB, and/or other similar network entities) providing connectivity to such UEs may communicate network packets. Particularly, network nodes may route and forward packets to destination UEs.

Various radio access technologies (RATs), such as Long Term Evolution (LTE) and 5G New Radio (NR), utilize a radio resource control (RRC) protocol at L3. As network nodes provide connectivity to UEs, the RRC protocol may provide functionality for connection establishment, transmission of system information, and so forth. For example, a UE may connect with a radio access network (RAN) through an RRC Connection Establishment procedure. Such an RRC Connection Establishment procedure may be implemented as a three-way handshake.

In some implementations of an RRC Connection Establishment procedure, the UE may select or reselect (collectively, (re)select) a cell provided by a network node and transmit an RRC Connection Request message to that network node. The RRC Connection Request message may be the first message in the three-way handshake. In response, the UE expects an RRC Connection Setup message from the network node. The RRC Connection Setup message may indicate radio resources allocated to the UE and/or other information related to bearer setup. The UE may close the three-way handshake by transmitting an RRC Connection Setup Complete message after receiving the RRC Connection Setup message.

However, a UE may not necessarily receive an RRC Connection Setup message in response to an RRC Connection Request message. Illustratively, the selected cell may have reached a threshold number of connections, the UE may be barred from accessing the selected cell, interference proximate to the UE may impede the message decoding process at the UE, and/or another factor(s) may occur that directly or indirectly prevents the UE from successfully receiving the RRC Connection Setup message from a network node.

Where a UE is unsuccessful in completing the three-way handshake for a selected cell, the UE may be configured to release radio resources, reattempt RRC Connection Establishment, and/or other operations discontinuing at least that connection establishment procedure through the selected cell. In some implementations, the UE may include a timer that is triggered in association with transmission of the RRC Connection Request message. Illustratively, the timer may be labeled Timer T300 when referenced with respect to some RATs. If the timer expires and the UE has not yet successfully received the RRC Connection Setup message, then the UE may determine that RRC Connection Establishment has failed. In some instances, the UE may retry transmission of the RRC Connection Request message to the network node.

Some network nodes providing cells selectable by UEs may configure a set of network-configured values respectively corresponding to a set of connection establishment failure parameters. When a UE selects such a cell, the UE may find and decode a set of information blocks, such as a master information block (MIB) and multiple system information blocks (SIBs). For example, the UE may receive a SIB1 that includes at least one information element (IE) associated with control of RRC Connection Establishment failure using a temporary offset—e.g., IE connEstFailureControl.

Such an IE may include a respective network-configured value for each of a set of parameters, including a failure count threshold (e.g., parameter connEstFailCount), an offset (e.g., parameter connEstFailOffset) by which to reduce a cell selection measurement associated with the selected cell, and/or an offset validity timer (e.g., parameter connEstFailOffsetValidity) indicating a duration for which the offset is to be applied to the cell selection measurement. Configuration of such parameters may prevent a UE from repeatedly (re)selecting the same cell for RRC Connection Establishment after a certain number of failed attempts.

When selecting a cell with which to attempt RRC Connection Establishment, a UE may camp on a cell to receive pilot signals (e.g., synchronization signals, reference signals, etc.) from a set of different candidate cells and measure the respective signal strengths or channel qualities for each. For example, the UE may measure at least one of a reference signal receive power (RSRP), reference signal receive quality (RSRQ), signal-to-noise ratio (SNR), signal-to-interference-plus-noise ratio (SINR), and/or another measurement indicative of channel conditions or energy on a set of resources.

The UE may select a cell on which to attempt RRC Connection Establishment, such as a cell corresponding to a pilot signal(s) from which the highest or “best” cell selection measurement was taken. Accordingly, the UE may attempt RRC Connection Establishment on the selected cell. If an attempt fails, such as where the UE fails to successfully receive and decode an RRC Connection Setup message on the selected cell after transmitting an RRC Connection Request message, the UE may increment (or decrement, in some configurations) a connection establishment failure counter.

While the connection establishment failure counter does not satisfy (e.g., does not meet or exceed) the failure count threshold (e.g., parameter connEstFailCount), the UE may reattempt RRC Connection Establishment on the selected cell, e.g., upon expiry of the T300 timer that was initiated based on transmission of an RRC Connection Request message. Once the connection establishment failure counter does satisfy (e.g., meets or exceeds) the failure count threshold, the UE may temporarily offset at least one cell selection measurement corresponding to the most recently selected cell—that is, the cell most recently associated with the connection establishment failure counter that satisfies the failure count threshold—and the UE may select another cell to attempt RRC Connection Establishment.

In some aspects, the UE may adjust (e.g., increment or decrement) the connection establishment failure counter upon each expiration of the T300 timer when the UE fails to successfully receive an RRC Connection Setup message within the duration of the T300 timer. Thus, if the UE supports RRC Connection Establishment failure with a temporary offset and the number of times that the T300 timer has expired (on the same cell that the UE received a SIBI having the connEstFailureControl IE) satisfies the failure count threshold (e.g., parameter connEstFailCount), then the UE may use the offset (e.g., parameter connEstFailOffset) in order to reduce a cell selection measurement associated with that cell.

The UE may temporarily apply the offset to one or more cell selection measurements corresponding to the cell on which the UE received the SIB1 having the connEstFailureControl IE. In particular, the UE may apply the offset for the duration of the offset validity timer (e.g., the value of parameter connEstFailOffsetValidity). Once the offset validity timer expires, the UE may remove the offset and resume collection of cell selection measurements, e.g., as the UE had prior to applying the offset.

In some aspects, the offset (e.g., parameter connEstFailOffset) may be used for the parameter Qoffsetₜₑₘₚ for a cell when performing cell selection and reselection, e.g., as defined according to the RAT in which the UE is operating. While the offset may be applied as Qoffsetₜₑₘₚ for a cell, the UE may still camp on that cell in order to perform cell (re)selection. Consequently, the UE may, in some circumstances, repeatedly select the same cell to which the offset is applied due to some errors or inefficiencies in configuring the UE to recover from RRC Connection Establishment failure. For example, the UE may select (potentially, repeatedly) a cell on which the offset is already being applied when: (1) a configuration for RRC Connection Establishment failure is absent from SIB1, and/or absent from other SIBs; (2) the network-configured values for one or more of the offset (e.g., parameter connEstFailOffset) and/or the offset validity timer (e.g., parameter connEstFailOffsetValidity) are insufficient in terms of reduction amount and/or duration to allow the UE to select or reselect to another cell; (3) the signal strength or power (e.g., RSRP measured by the UE) associated with signals transmitted in the cell is substantial enough that acceptable offsets (such as a maximum allowable value for Qoffsetₜₑₘₚ) are insufficient to reduce a cell selection measurement below other cell selection measurements collected for other cells; and/or (4) for inter-RAT UEs, “ping-pong” reselection may occur where the UE repeatedly selects back and forth between the same two inter-RAT cells because the offset is not applied to the cell when the UE uses inter-RAT reselection evaluation (e.g., as opposed to intra-RAT reselection evaluation).

In view of the foregoing, there exists a need for mechanisms preventing a UE from repeatedly (re)selecting to one cell (or a small number of cells) after repeated RRC Connection Establishment failures. The present disclosure provides various techniques and solutions that may enable a UE to (re)select to a suitable cell through which the UE may connect, for example, after the UE experiences one or multiple RRC Connection Establishment failures or other similar connection (re)establishment issues.

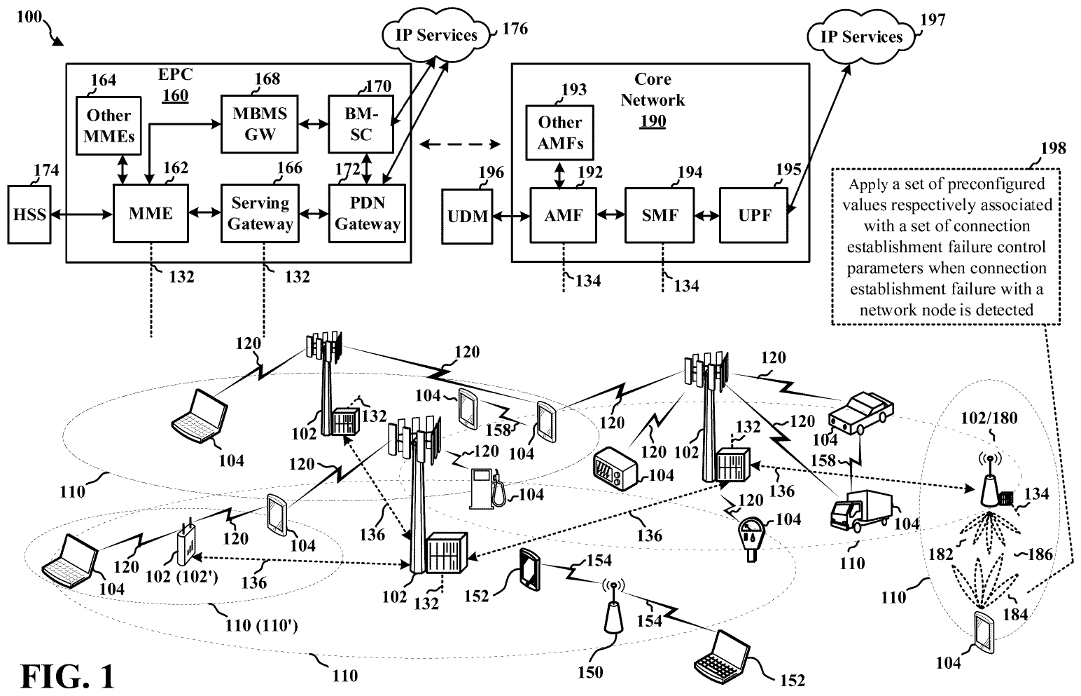

FIG. 1 is a diagram illustrating an example of a wireless communications system and an access network 100. The wireless communications system (also referred to as a wireless wide area network (WWAN)) includes network nodes 102, UEs 104, an Evolved Packet Core (EPC) 160, and another core network 190 (e.g., a 5G Core (5GC)). The network nodes 102 may include macrocells (e.g., provided by a high power cellular base stations or other network nodes) and/or small cells (e.g., low power cellular base stations or other network nodes). The macrocells can include base stations, nodeBs, eNBs, and/or gNBs. The small cells include femtocells, picocells, and microcells.

The network nodes 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The network nodes 102 configured for 5G NR, which may be collectively referred to as Next Generation radio access network (RAN) (NG-RAN), may interface with core network 190 through second backhaul links 134. In addition to other functions, the network nodes 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the network nodes 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the network nodes 102 may be configured for integrated access and backhaul (IAB). Accordingly, such network nodes may wirelessly communicate with other network nodes, which also may be configured for IAB.

At least some of the network nodes 102 configured for IAB may have a split architecture that includes at least one of a central unit (CU), a distributed unit (DU), a radio unit (RU), a RRH, and/or a remote unit, some or all of which may be collocated or distributed and/or may communicate with one another. In some configurations of such a split architecture, a CU may implement some or all functionality of an RRC layer, whereas a DU may implement some or all of the functionality of a radio link control (RLC) layer.

Illustratively, some of the network nodes 102 configured for IAB may communicate through a respective CU with a DU of an IAB donor node or other parent IAB node (e.g., a network node), and further, may communicate through a respective DU with child IAB nodes (e.g., other network nodes) and/or one or more of the UEs 104. One or more of the network nodes 102 configured for IAB may be an IAB donor connected through a CU with at least one of the EPC 160 and/or the core network 190. With such a connection to the EPC 160 and/or core network 190, a network node 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the network nodes 102 may be configured with connectivity in an open RAN (ORAN) and/or a virtualized RAN (VRAN), which may be enabled through at least one respective CU, DU, RU, RRH, and/or remote unit.

The network nodes 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the network nodes 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro network nodes 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the network nodes 102 and the UEs 104 may include uplink (also referred to as reverse link) transmissions from a UE 104 to a network node 102 and/or downlink (also referred to as forward link) transmissions from a network node 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The network nodes 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a network node at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A network node 102, whether a small cell 102′ or a large cell (e.g., macro base station), may include and/or be referred to as an eNB, gNodeB (gNB), or another type of network node. Some network nodes 180, such as gNBs, may operate in a traditional sub 6 GHz spectrum, in mmW frequencies, and/or near-mmW frequencies in communication with the UE 104. When such a network node 180 (e.g., gNB) operates in mmW or near-mmW frequencies, the network node 180 may be referred to as a mmW network node. The (mmW) network node 180 may utilize beamforming 186 with the UE 104 to compensate for the path loss and short range. The network node 180 and the UE 104 may each include a plurality of antennas, such as antenna elements, antenna panels, and/or antenna arrays to facilitate the beamforming.

The network node 180 may transmit a beamformed signal to the UE 104 in one or more transmit directions 182. The UE 104 may receive the beamformed signal from the network node 180 in one or more receive directions 184. The UE 104 may also transmit a beamformed signal to the network node 180 in one or more transmit directions. The network node 180 may receive the beamformed signal from the UE 104 in one or more receive directions. One or both of the network node 180 and/or the UE 104 may perform beam training to determine the best receive and/or transmit directions for the one or both of the network node 180 and/or UE 104. The transmit and receive directions for the network node 180 may or may not be the same. The transmit and receive directions for the UE 104 may or may not be the same.

In various different aspects, one or more of the network nodes 102/180 may include and/or be referred to as a gNB, Node B, eNB, an access point, a base transceiver station, a radio network node, a radio transceiver, a transceiver function, a basic service set (BSS), an extended service set (ESS), a transmit reception point (TRP), or some other suitable terminology.

In some aspects, one or more of the network nodes 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the network nodes 102 belonging to a Multicast Broadcast Single Frequency Network (MBSFN) area broadcasting a particular service, and may be responsible for session management (start/stop) and for collecting eMBMS related charging information.

In some other aspects, one or more of the network nodes 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, the UE 104 may be configured to detect a connection establishment failure associated with a network node 102/180. The UE 104 may be further configured to apply a set of preconfigured values respectively associated with a set of connection establishment failure control parameters when the connection establishment failure is detected (198).

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

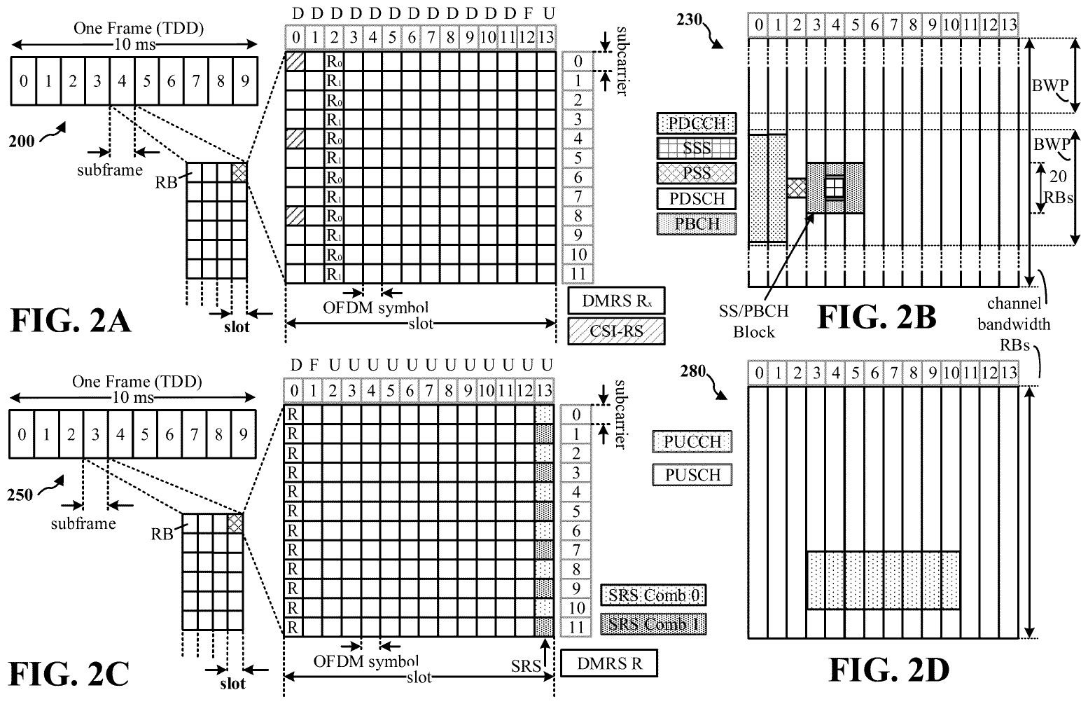

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24⁻ slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rₓ for one particular configuration, where 100x is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a MIB, may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the network node. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a network node for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

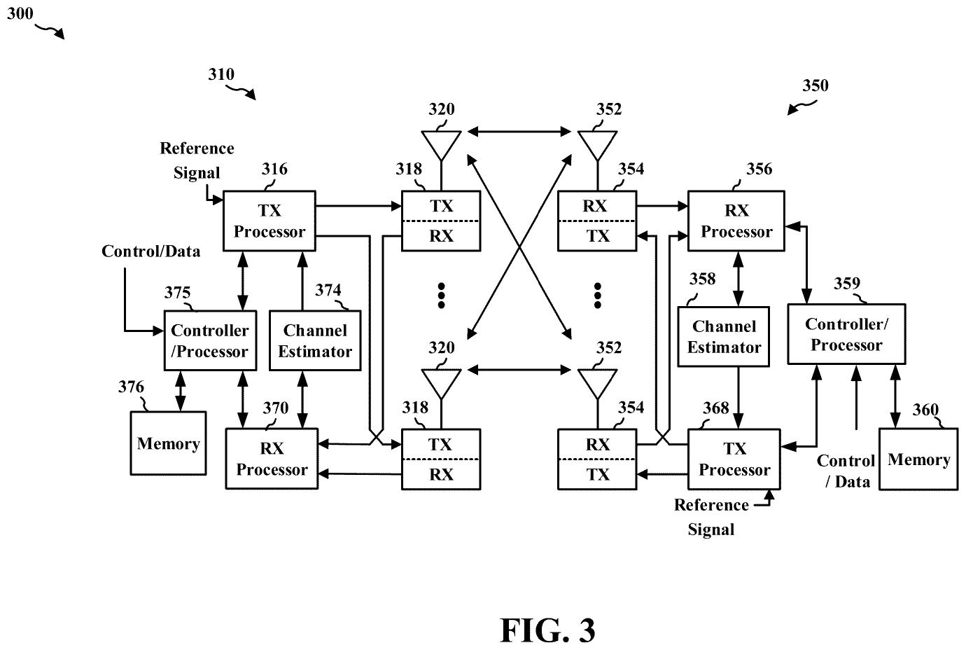

FIG. 3 is a block diagram of a network node 310 in communication with a UE 350 in an access network 300. In the downlink, IP packets from the EPC 160 may be provided to a controller/processor 375. The controller/processor 375 implements Layer 2 (L2) and L3 functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a PHY layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the network node 310. These soft decisions may be based on channel estimates computed by the channel estimator 358. The soft decisions are then decoded and deinterleaved to recover the data and control signals that were originally transmitted by the network node 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the network node 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the network node 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the network node 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with (198) of FIG. 1.

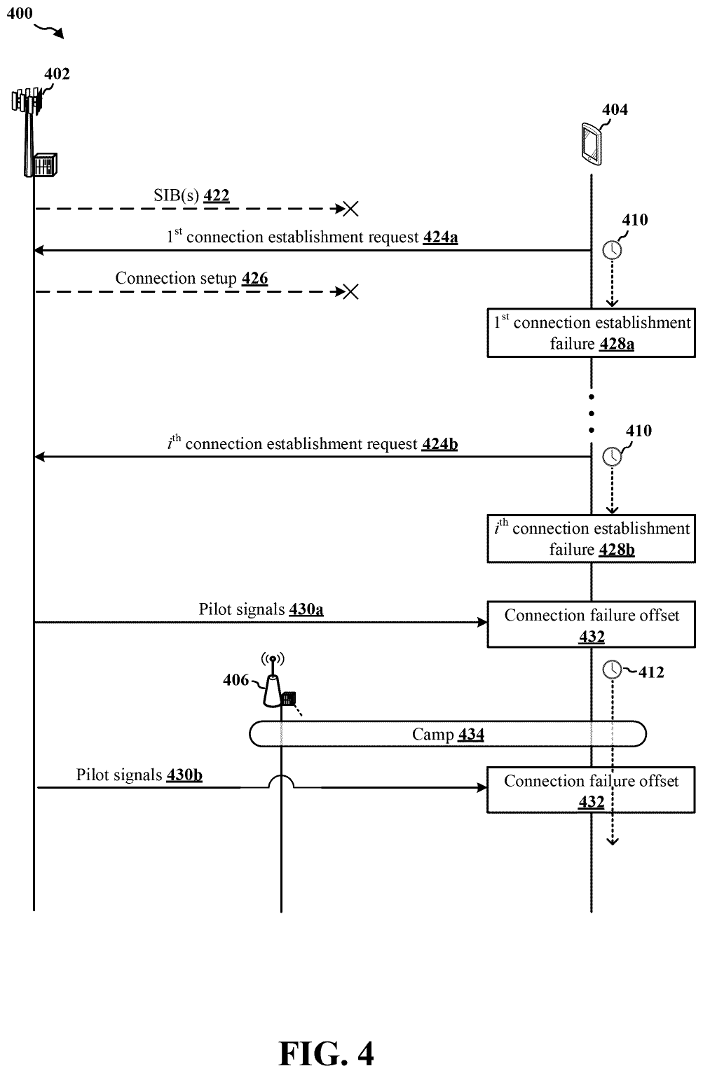

FIG. 4 is a call flow diagram 400 illustrating example operations by a UE 404 for recovery from failure of at least one connection establishment procedure with a network node 402. The network node 402 may be configured to transmit (e.g., broadcast) information facilitating the cell selection and reselection of the network node 402. For example, the network node 402 may periodically broadcast a MIB and multiple SIBs, including the SIB 422 (e.g., a SIB1) to facilitate connectivity of various UEs.

In some examples, the network node 402 may broadcast a SIB 422 (e.g., SIB1) having an IE related to control of RRC Connection Establishment failure (e.g., connEstFailureControl IE). In such examples, the connEstFailureControl IE may include a set of network-configured values respectively corresponding to the abovementioned parameters of the connEstFailureControl IE. That is, the network node 402 may indicate, via a SIB 422, at least one of a network-configured value for a failure count threshold (e.g., parameter connEstFailCount), an offset (e.g., parameter connEstFailOffset) by which to reduce a cell selection measurement associated with the selected cell, and/or an offset validity timer (e.g., parameter connEstFailOffsetValidity) indicating a duration for which the offset is to be applied to the cell selection measurement.

Configuration of such parameters may prevent a UE from repeatedly (re)selecting the same cell for RRC Connection Establishment after a certain number of failed attempts. In particular, for some conventional UEs that support recovery from RRC Connection Establishment failure using temporary offsets, the values of the various parameters may only be available through network configuration and broadcast in a SIB 422. This arrangement may leave UEs vulnerable in some instances. Illustratively, interference may appreciably affect a UE's capability to find and decode some signaling, causing the UE to fail to successfully receive the SIB 422 having the set of network-configured values. In another example, the network node 402 may fail to include the set of network-configured values in the SIB 422, e.g., because the network node 402 lacks the capability or has not itself been configured to include the set of network-configured values in the SIB 422.

Absent such network configuration, some such UEs may experience poor performance during cell selection and reselection. For example, UEs may repeatedly unsuccessfully attempt RRC Connection Establishment on the same cells without fast and/or efficient mechanisms of inducing selections to new cells on which the UEs may have greater successes in connection attempts.

According to various aspects of the present disclosure, however, the UE 404 may be configured to support recovery from RRC Connection Establishment failure even where the UE 404 fails to find and decode a SIB 422 that includes a set of network-configured values respectively corresponding to the parameters of the connEstFailureControl IE. For example, the UE 404 may include a set of preconfigured values respectively corresponding to at least one of the parameters included in the connEstFailureControl IE. In some aspects, at least a subset of the set of preconfigured values may be configured in the UE 404 at a point of manufacture. For example, the UE 404 may include a memory or storage device that is hardcoded with the set of preconfigured values. In some other aspects, the UE 404 may include a memory and/or storage device that stores the set of preconfigured values, but the set of preconfigured values may be periodically or aperiodically updated.

In some aspects, the UE 404 may include a set of preconfigured values that are preconfigured with respect to a network node, a RAN, or a similar system, device, or apparatus. That is, the UE 404 may receive one or more of the set of preconfigured values, for example, over a radio access or other wireless network (e.g., from a network node). However, the one or more of the set of preconfigured values may be considered preconfigured with respect to another network node, another radio access or wireless network, or other similar system, device, or apparatus different from that via which the UE 404 received the one or more of the set of preconfigured values. As the one or more of the set of preconfigured values were stored in memory or other storage device of the UE 404 prior to the UE 404 establishing a connection with, operating on, and/or otherwise communicating with the other network node, other radio access or wireless network, or other similar system, device, or apparatus, the configuration of the one or more of the set of preconfigured values predated the connection or communication between the UE 404 and the other network node, other radio access or wireless network, or other similar system, device, or apparatus.

The UE 404 may be configured to apply the set of preconfigured values respectively associated with the parameters of the connEstFailureControl IE. For example, the UE 404 may default to the set of preconfigured values for the set of connection establishment failure control parameters when the connection establishment failure is detected and a set of network-configured values associated with the set of connection establishment failure control parameters has not been received from the network node 402 (e.g., where connEstFailureControl IE is absent from or not configured in the SIB 422). In other words, the UE 404 may default to applying the set of preconfigured values for recovery from and/or control of connection establishment failure. In contrast, other UEs may default to an operational mode in which the other UEs refrain from temporarily offsetting any cell selection measurements, potentially allowing the other UEs to repeatedly select the same cell multiple times despite repeated connection establishment failures.

In some aspects, when the UE 404 both includes a set of preconfigured values respectively corresponding to connection establishment failure control parameters and receives a set of network-configured values respectively corresponding to the connection establishment failure parameters, the UE 404 may be configured to default to one set of values. For example, the UE 404 may default to using the set of network-configured values respectively corresponding to the connection establishment failure parameters. Potentially, the other set of values (e.g., the set of preconfigured values) may be unused by the UE 404.

In association with cell (re)selection, the UE 404 may transmit a first connection establishment request 424a to the network node 402 providing the cell selected by the UE 404. In some aspects, the first connection establishment request 424a may be an RRC Connection Request message. Based on transmitting the first connection establishment request 424a, the UE 404 may initiate a connection establishment timer 410, such as timer T300. The duration of the connection establishment timer 410 may define the period during which the UE 404 expects to receive a connection setup message 426 (e.g., an RRC Connection Setup message) in response to the first connection establishment request 424a.

In some instances, however, the UE 404 may fail to receive a connection setup message 426 from the network node 402 prior to the expiration of the connection establishment timer 410. In some other instances, the UE 404 may receive a connection rejection message in response to the first connection establishment request 424a. When the connection establishment timer 410 expires and the connection setup message 426 has not been received, or potentially, when the UE 404 receives a connection rejection message from the network node 402, the UE 404 may detect that the connection establishment procedure with the network node 402 is a connection establishment failure 428a.

The UE 404 may count the number of detected connection establishment failures according to those failures occurring on the same cell, e.g., provided by the network node 402. For example, the UE 404 may increment a connection establishment failure counter. In some aspects, the UE 404 may adjust (e.g., increment or decrement) the connection establishment failure counter upon each expiration of the connection establishment timer 410 when the UE 404 fails to successfully receive a connection setup message 426 within the duration of the connection establishment timer 410.

The UE 404 may compare the connection establishment failure counter to one of the set of preconfigured values corresponding to the failure count threshold (e.g., parameter connEstFailCount). The UE 404 may determine whether the connection establishment failure counter satisfies (e.g., meets or exceeds) the failure count threshold based on the comparison. If the UE 404 determines that the connection establishment failure counter fails to satisfy (e.g., is less than) the failure count threshold, then the UE 404 may proceed to transmit the next connection establishment request, such as the i^{th} connection establishment request 424b. Accordingly, the UE 404 may restart the connection establishment timer 410 in association with transmission of the i^{th} connection establishment request 424b.

However, if the UE 404 determines that the connection establishment failure counter satisfies (e.g., is greater than or equal to) the failure count threshold, then the UE 404 may proceed to apply one of the set of preconfigured values that corresponds to an offset (e.g., parameter connEstFailOffset) and another of the set of preconfigured values that corresponds to an offset validity timer (e.g., parameter connEstFailOffsetValidity) based on the detection of the connection establishment failure (e.g., based on detection of the i^{th} connection establishment failure 428b that satisfies the failure count threshold).

The UE 404 may temporarily apply a connection failure offset 432 to one of the set of preconfigured values corresponding to the offset (e.g., parameter connEstFailOffset) to one or more cell selection measurements corresponding to the cell on which the UE 404 transmitted the connection establishment requests 424a-424b. To apply the connection failure offset 432, the UE 404 may determine (e.g., calculate, compute, measure, observe) at least one cell selection measurement (e.g., RSRP, RSRQ, SNR, SINR, etc.) based on receiving a set of pilot signals (e.g., SSB(s), CSI-RS(s), etc.) from the network node 402, and the UE 404 may subtract or reduce the cell selection measurement by the connection failure offset 432. In theory, this connection failure offset 432 may prevent the cell on which the UE 404 was unable to successfully complete connection establishment from being selected when the UE 404 performs cell (re)selection.

In some aspects, the UE 404 may temporarily apply the connection failure offset 432. For example, the UE 404 may apply one of the preconfigured values corresponding to an offset validity timer 412 when applying the connection failure offset 432 to reduce the cell selection measurement(s) associated with the cell provided by the network node 402. The UE 404 may initiate the offset validity timer 412 in association with applying the connection failure offset 432 to cell selection measurements recorded from one or more sets of pilot signals. Upon expiration of the offset validity timer 412, the UE 404 may refrain from applying or may remove the connection failure offset 432 and otherwise refrain from intentionally reducing the cell selection measurements associated with the network node 402.

In some aspects, the UE 404 may use the connection failure offset 432 for the parameter Qoffsetₜₑₘₚ for a cell when performing cell (re)selection, e.g., as defined according to the RAT in which the UE 404 is operating. While the connection failure offset 432 may be applied as Qoffsetₜₑₘₚ for a cell, the UE 404 may still camp on that cell in order to perform cell (re)selection. Consequently, the UE 404 may, in some circumstances, repeatedly select the same cell to which the connection failure offset 432 is applied due to some errors or inefficiencies in configuring the UE 404 to recover from RRC Connection Establishment failure.

For example, the set of network-configured values for the connection establishment failure control parameters may be insufficient to offset the cell selection measurements of one cell relative to other proximate cells, such as when the value of the set of network-configured values corresponding to the offset (e.g., parameter connEstFailOffset) is too low or when the value of the one of the set of network-configured values corresponding to the offset validity timer (e.g., parameter connEstFailOffsetValidity) is too short in duration to cause a meaningful reduction in the cell selection measurements for pilot signals 430a received from the network node 402.

In another example, the power or energy from the cell on which to apply the connection failure offset 432 may be too great to be meaningfully offset by the configured offset value. Illustratively, the parameter Qoffsetₜₑₘₚ may be configurable up to a maximum amount, and that maximum amount may be insufficient to meaningfully offset a cell selection measurement(s) from the cell on which to apply the connection failure offset 432. Consequently, a UE may select the same cell at other cell (re)selections even though the UE had repeatedly been unable to a customer support representative. Thus, the UE 404 may additionally or alternative include the power blocks and dumbbells.

Potentially, the UE 404 may apply both a set of network-configured values and a set of preconfigured values, e.g. in instances in which the set of network-configured values. For example, the UE 404 may receive a SIB 422 including a set of network-configured values N, T, P for the connection establishment failure control parameters failure count threshold, offset validity timer, and offset, respectively. Further, the UE 404 may include a set of preconfigured values X, Y, Z for the connection establishment failure control parameters failure count threshold, offset validity timer, and offset, respectively. The UE 404 may apply the set of network-configured values during a first number of connection establishment failures. In the first round of connection establishment attempts, the set of network-configured values from the SIB 422 may be conventionally applied. For example, the UE 404 may select a cell on which to attempt connection establishment and if the UE 404 determines that the cell has not been previously selected for connection establishment, then the UE 404 may apply the set of network-configured values for the corresponding connection establishment failure control parameters, and the set of preconfigured values may be unused.

Illustratively, the UE 404 may increment a connection establishment failure counter based on each connection establishment failure until the counter satisfies the failure count threshold N. The UE may then apply the offset P for the duration of the offset validity timer T.

For each cell to which the UE 404 applies the connection failure offset 432, the UE 404 may record or store information associated with each of the cells in a database (e.g., a local database of the UE 404). For example, the UE 404 may record information related to the network node 402 and/or a cell provided thereby when the UE 404 has selected the cell provided by the network node 402, e.g., when a connection establishment failure counter based on each connection establishment failure with the network node 402 satisfies one of the set of preconfigured values corresponding to the failure count threshold. Illustratively, the UE 404 may store information indicating that the cell provided by the network node 402 has been selected and a connection establishment failed with the values P and T for the offset and offset validity timer, respectively.

When the UE 404 performs cell (re)selection, the UE 404 may compare the selected cell with the information stored in the database to determine whether the UE 404 has previously selected the same cell. If the UE 404 has not previously selected the same cell, then the UE 404 may proceed with the set of network-configured values, as described herein. However, if the UE 404 has previously selected the same cell, then the UE 404 may augment or enhance the set of network-configured values with the set of preconfigured values.

Illustratively, the UE 404 may select the cell provided by the network node 402 for a second time after connection establishment failed over the first N attempts. As the UE 404 has already reached N connection establishment failures, the UE 404 may perform up to another X connection establishment attempts. However, for the remaining connection establishment attempts, the UE 404 may augment the offset validity timer 412 with Y and the offset with Z so that the offset validity timer 412 would be equal to T+Y and the offset would be equal to P+Z. In effect, for those cells selected an additional time after connection establishment failed over the first N attempts (e.g., those cells existing in the database), the UE 404 may apply a larger offset over a greater time period, which may result in those cells selected additional times being less likely to be selected. The UE 404 may further update information associated with a cell that is selected more than N times to reflect that the offset validity timer 412 should be set to T+Y and the offset should be set to P+Z, e.g., in case the cell were to be selected again in the future.

In some aspects, the UE 404 may be configured for inter-RAT operability, and the UE 404 may be able to select between a network node 402 of one RAT (e.g., a 5G NR RAT) and another node 406 of another RAT (e.g., an LTE RAT). The UE 404 may perform inter-RAT operability procedures for cell (re)selection based on some inter-RAT criteria, condition(s), or event(s). For example, the UE 404 may select between the network node 402 and the other node 406 based on relative comparison of cell selection measurements recorded from pilot signals received from each of the nodes 402, 406 and inter-RAT handover criteria defined for LTE to NR (L2NR) or NR to LTE (NR2L).

Illustratively, the UE 404 may fail to establish a connection through the cell provided by the network node 402 (e.g., an NR cell). Therefore, as described herein, the UE 404 may apply the connection failure offset 432 after the i^{th} connection establishment failure 428b is determined to satisfy the failure count threshold. The UE 404 may perform cell (re)selection, and the UE 404 may identify the other node 406 of the other RAT as a candidate cell upon which the UE 404 may camp.

During cell (re)selection, the UE 404 may select a cell of the other RAT provided by the other node 406, e.g., based on pilot signals received from the other node 406 and pilot signals 430a received from the network node 402 while cell selection measurements associated with the network node 402 are still subject to the connection failure offset 432 (that is, the offset validity timer 412 may be unexpired). In some aspects, the UE 404 may select the other node 406 based on one or more NR2L measurements and/or NR2L criteria.

When the UE 404 selects the cell of the other node 406, the UE 404 may camp 434 on the selected cell of the other node 406. While the UE 404 camps 434 on the selected cell, the UE 404 may perform cell (re)selection and, as before, the UE 404 may consider cells from both RATs if configured for inter-RAT operability. However, the network node 402 may still be active in the database of the UE 404. For example, the offset validity timer 412 may be unexpired during L2NR cell (re)selection.

The connection establishment failure parameters may not necessarily be intended or expected for operation in the other RAT and/or of inter-RAT operation. Therefore, the UE 404 may not be expected to apply (or continue applying) the connection failure offset 432 when performing L2NR cell (re)selection. Regardless, the network node 402 may be an undesirable target cell due to the recent connection establishment failures 428a-428b that occurred.

According to some aspects, the UE 404 may be configured to apply the connection failure offset 432 during L2NR cell (re)selection. For example, the UE 404 may determine that cell selection measurements associated with the network node 402 should be subject to an offset even during L2NR cell (re)selection if the UE 404 finds the network node 402 is activated in the database. The network node 402 may be activated in the database where the offset validity timer 412 would be unexpired, where the UE 404 identifies the network node 402 the database (e.g., where the UE 404 records a finite number of cells, such as those cells most recently subject to the connection failure offset 432), or another condition(s).

Thus, when the UE 404 performs L2NR cell (re)selection and performs cell selection and/or L2NR measurements, the UE 404 may determine that the connection failure offset 432 should be applied to the cell selection measurement(s) associated with the network node 402. Therefore, when the UE 404 receives pilot signals 430b from the network node 402 and records cell selection measurements based thereon, the UE 404 may apply the connection failure offset 432 (or another offset) to the cell selection measurements associated with the network node 402 even in L2NR cell (re)selection.

Accordingly, the UE 404 may avoid selecting the cell of the network node 402 for connection establishment, e.g., where the UE 404 has recently experienced connection establishment failures 428a-428b on the cell provided by the network node 402. By avoiding the network node 402, the UE 404 may select another cell (e.g., a cell of the same RAT as the network node 402) on which the UE 404 may be more likely to experience a successful connection establishment procedure.

In some aspects, the offset validity timer 412 and/or the connection failure offset 432 may be preconfigured with respect to the other RAT and/or other node 406. For example, the UE 404 may obtain values for the offset validity timer 412 and/or the connection failure offset 432 from a SIB 422 received from the network node 402 (e.g., of one RAT); however, those values may be preconfigured in the UE 404 with respect to the other node 406 and/or other RAT, e.g., as the values of the offset validity timer 412 and/or the connection failure offset 432 may have been received and stored by the UE 404 prior to the cell (re)selection that included the other node 406 and/or other RAT.

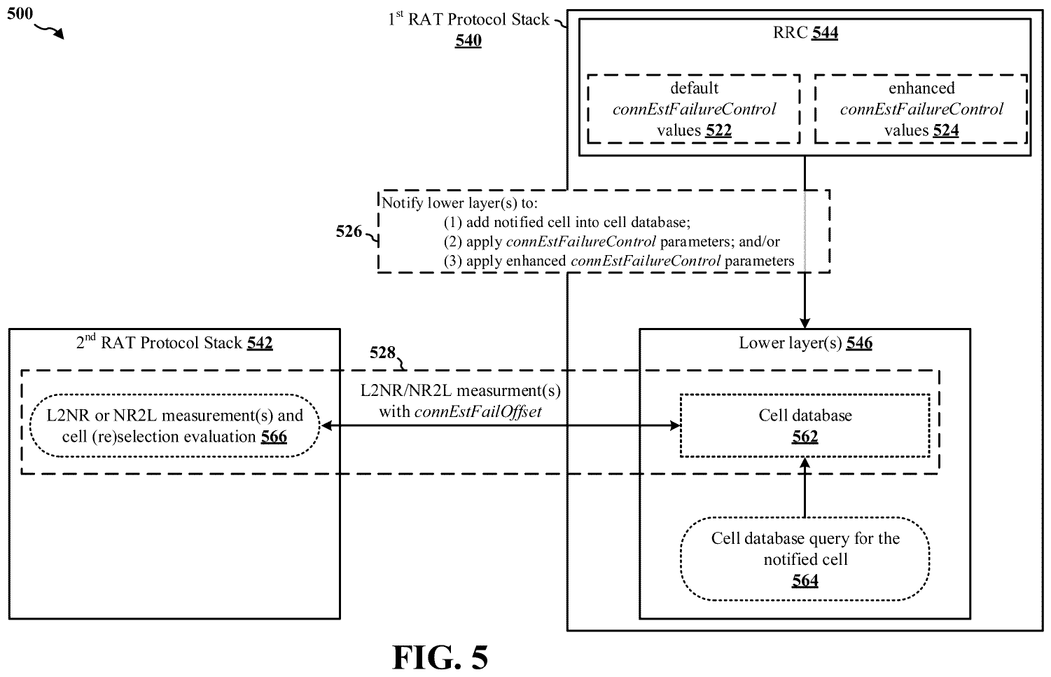

FIG. 5 is a block diagram 500 illustrating an example flow of operations over conceptual protocol stacks 540, 542 of a UE that supports recovery from connection establishment failure using a temporary offset. In some aspects, the UE may be configured for inter-RAT operability, and therefore, the UE may include a first protocol stack 540 of a first RAT (e.g., a 5G NR RAT or an LTE RAT) and a second protocol stack 542 of a second RAT (e.g., an LTE RAT or a 5G NR RAT).

The first protocol stack 540 may include at least an RRC layer 544. The RRC layer may implement the protocol according to which the UE communicates over the air with network nodes (e.g., base stations, gNBs, RRHs, etc.) of the first RAT. The UE may perform cell (re)selection and connection establishment with a network node of the first RAT through the RRC layer 544.

Where the UE finds that connection establishment through a selected cell fails a threshold number of times, the RRC layer 544 may support temporarily offsetting cell selection measurements associated with the selected cell for a time period following the threshold number of connection establishment failures. The values of the threshold number of connection establishment failures, the temporary offset, and the time period for applying the temporary offset may be expected from a connEstFailureControl IE of a SIB.

In the absence of such a connEstFailureControl IE, the RRC layer 544 may be configured with a default connEstFailureControl values 522, which may include a set of preconfigured values for a set of connection establishment failure control parameters otherwise expected in the connEstFailureControl IE. For example, the default connEstFailureControl values 522 may include respective values of a connEstFailCount parameter, a connEstFailOffset parameter, and/or a connEstFailOffsetValidity parameter to which the RRC layer 544 may default in the absence of a connEstFailureControl IE. As the default connEstFailureControl values 522 is the default state of the RRC layer 544, the RRC layer 544 may be able to support temporarily offsetting cell selection measurements associated with a selected cell for a time period following a threshold number of connection establishment failures on the selected cell.

Additionally or alternatively, the RRC layer 544 may be configured with a set of enhanced connEstFailureControl values 524. The enhanced connEstFailureControl values 524 may be intended to enhance or augment connEstFailureControl values that are initially used for connection establishment failure control. In some aspects, the enhanced connEstFailureControl values 524 may be preconfigured. The enhanced connEstFailureControl values 524 may be used with both the default connEstFailureControl values 522 and network-configured connEstFailureControl values received from a network node.

In some aspects, the enhanced connEstFailureControl values 524 may include a set of values that indicate an amount by which to adjust the default connEstFailureControl values 522 (or network-configured connEstFailureControl values) in instances in which the UE selects a cell for connection establishment that has already been selected but on which connection establishment failed a threshold number of times.

At the RRC layer 544, a T300 timer may be triggered upon initiation of each connection establishment procedure (e.g., upon transmission of a connection establishment request, such as an RRC Connection Request message). If a connection setup message is not received before expiration of the T300 timer, then the RRC layer 544 may consider the connection establishment procedure as failed. When a threshold number of connection establishment failures have occurred, the RRC layer 544 may notify 526 at least one lower layer 546 of the UE, such as a PHY layer and/or MAC layer.

In some aspects, when the RRC layer 544 notifies 526 the lower layer 546, the RRC layer 544 may instruct the lower layer 546 to store information identifying the cell on which the threshold number of connection establishment failures occurs in a cell database 562. In addition, the RRC layer 544 may notify 526 the lower layer 546 to apply the values of the connEstFailureControl parameters (e.g., the default connEstFailureControl values 522 or network-configured connEstFailureControl values). Further, the RRC layer 544 may notify 526 the lower layer 546 to apply the values 524 of the enhanced connEstFailureControl parameters, if applicable.

Based on the notification, the lower layer 546 may be configured to add the notified cell into the cell database 562 and perform cell (re)selection. In response the lower layer 546 may query 564 the cell database 562 for the notified cell. If the notified cell does not exist or is not activated in the cell database 562, the lower layer 546 may add the notified cell to the database 562 and may use a default or network-configured value of the connEstFailOffset parameter for a default or network-configured duration of a connEstFailOffsetValidity parameter on the notified cell during cell (re)selection.

If, however, the notified cell does exist or is activated in the cell database 562, the lower layer 546 may update the notified cell in the database 562, and may offset the notified cell based on both a default or network-configured value of the connEstFailOffset parameter and an enhanced connEstFailOffset value for a duration that is based on a default or network-configured duration of a connEstFailOffsetValidity parameter and an enhanced connEstFailOffsetValidity value during cell (re)selection.

If a cell of second RAT is selected during cell (re)selection, then the UE may camp on the cell of the second RAT. The second RAT protocol stack 542 may perform L2NR or NR2L measurements 566 to evaluate and (re)select a cell. The lower layer 546 of the first RAT protocol stack 540 and/or the second RAT protocol stack 542 may offset 528 L2NR or NR2L measurements 566 of the notified cell by a default or network-configured value of the connEstFailOffset parameter, e.g., for a default or network-configured duration of a connEstFailOffsetValidity parameter. In some aspects, if the notified cell exists in the database 562, the lower layer 546 of the first RAT protocol stack 540 and/or the second RAT protocol stack 542 may offset 528 L2NR or NR2L measurements 566 of the notified cell.

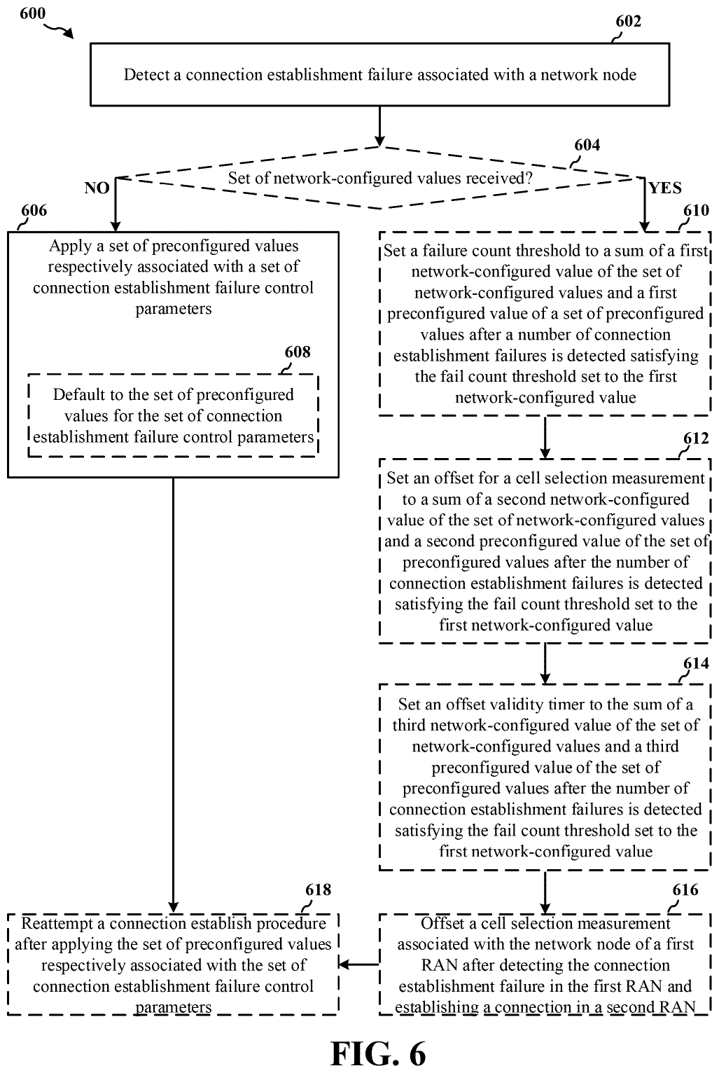

FIG. 6 is a flowchart 600 illustrating an example of a method of recovering from failure of at least one connection establishment procedure. The method may be performed by or at a UE (e.g., the UE 104, 350, 404), another wireless communications apparatus (e.g., the apparatus 702), or one or more components thereof. According to various different aspects, one or more of the illustrated blocks may be omitted, transposed, and/or contemporaneously performed.

At 602, the UE may detect a connection establishment failure associated with a network node. For example, the UE may transmit a connection establishment request message to a selected cell and trigger a T300 timer based thereon. The UE may determine if a connection setup message has been received before expiration of the T300 timer. If the UE does not receive a connection setup message from the selected cell before expiration of the T300 timer, then the UE may detect the connection establishment failure.

Referring to FIG. 4, the UE 404 may detect the connection establishment failures 428a-428b upon expiration of the T300 timer 410 when the connection setup message 426 is absent.

At 604, the UE may determine whether a set of network-configured values for a connEstFailureControl IE has been received. For example, the UE may receive a SIB1 from a network node. The UE may determine whether connEstFailureControl IE in the SIB1 includes values for a set of parameters.

Referring to FIG. 4, the UE 404 may determine whether a set of network-configured values for a connEstFailureControl IE has been received from the network node 402.

If the UE determines that the set of network configured values has not been received, then:

At 606, the UE may apply a set of preconfigured values respectively associated with a set of connection establishment failure control parameters. For example, the UE may determine an offset parameter has not been configured by the network, and the UE may set the offset parameter to one of the preconfigured values. In another example, the UE may determine an offset validity timer parameter has not been configured by the network, and the UE may set the offset validity timer to another of the preconfigured values. In still another example, the UE may determine a failure count threshold parameter has not been configured by the network, and the UE may set the failure count threshold to a third of the preconfigured values.

Referring to FIGS. 4-5, the UE 404 may apply the default connEstFailureControl values 522 respectively associated with a set of connection establishment failure control parameters.

In some aspects of 606, 608 may be performed. At 608, the UE may default to the set of preconfigured values for the set of connection establishment failure control parameters. For example, the UE may determine that a set of parameters for connection establishment failure control are equal to null or are otherwise not configured, and based thereon, the UE may set values of the null or non-configured parameters based on preconfigured values corresponding to the set of parameters.

Referring to FIGS. 4-5, the UE 404 may default to the default connEstFailureControl values 522 respectively associated with a set of connection establishment failure control parameters.

At 618, the UE may reattempt a connection establishment procedure after applying the set of preconfigured values respectively associated with the set of connection establishment failure control parameters. For example, the UE may (re)select another cell and the UE may transmit a connection request message to the network node of the selected cell.

Referring to FIGS. 4-5, the UE 404 may reattempt a connection establishment procedure after applying the default connEstFailureControl values 522 respectively associated with the set of connection establishment failure control parameters.

If the UE determines that the set of network configured values has been received, then:

At 610, the UE may set a failure count threshold to a sum of a first network-configured value of the set of network-configured values and a first preconfigured value of a set of preconfigured values after a number of connection establishment failures is detected satisfying the failure count threshold set to the first network-configured value. For example, the UE may determine a number of connection establishment failures that satisfy a failure count threshold set to a first network-configured value. If the UE determines that the number satisfies the threshold, then the UE may add a first preconfigured value of a set of preconfigured values to a first network-configured value of a set of network-configured values, and the UE may set the failure count threshold to the sum.

Referring to FIGS. 4-5, the UE 404 may set a failure count threshold parameter of the connEstFailureControl parameters to a sum of a first network-configured value for the connEstFailCount parameter and a first one of the enhanced connEstFailureControl values 524 after a number of connection establishment failures 428a-428b is detected satisfying the failure count threshold set to the first network-configured value for the connEstFailCount parameter.

At 612, the UE may set an offset for a cell selection measurement to a sum of a second network-configured value of the set of network-configured values and a second preconfigured value of the set of preconfigured values after the number of connection establishment failures is detected satisfying the fail count threshold set to the first network-configured value. For example, the UE may determine a number of connection establishment failures that satisfy a failure count threshold set to a first network-configured value. If the UE determines that the number satisfies the threshold, then the UE may add a second preconfigured value of a set of preconfigured values to a second network-configured value of a set of network-configured values, and the UE may set an offset to the sum.

Referring to FIGS. 4-5, the UE 404 may set the connection failure offset 432 (e.g., connEstFailOffset or Qoffsetₜₑₘₚ) of the connEstFailureControl parameters to a sum of a second network-configured value for the connEstFailOffset parameter and a second one of the enhanced connEstFailureControl values 524 after a number of connection establishment failures 428a-428b is detected satisfying the failure count threshold set to the first network-configured value for the connEstFailCount parameter.

At 614, the UE may set an offset validity timer to the sum of a third network-configured value of the set of network-configured values and a third preconfigured value of the set of preconfigured values after the number of connection establishment failures is detected satisfying the fail count threshold set to the first network-configured value. For example, the UE may determine a number of connection establishment failures that satisfy a failure count threshold set to a first network-configured value. If the UE determines that the number satisfies the threshold, then the UE may add a third preconfigured value of a set of preconfigured values to a third network-configured value of a set of network-configured values, and the UE may set an offset validity timer to the sum.

Referring to FIGS. 4-5, the UE 404 may set the offset validity timer 412 (e.g., connEstFailOffsetValidity) of the connEstFailureControl parameters to a sum of a third network-configured value for the connEstFailOffsetValidity parameter and a third one of the enhanced connEstFailureControl values 524 after a number of connection establishment failures 428a-428b is detected satisfying the failure count threshold set to the first network-configured value for the connEstFailCount parameter.

At 616, the UE may offset a cell selection measurement associated with the network node of a first RAN after detecting the connection establishment failure in the first RAN and establishing a connection in a second RAN. For example, the UE may camp on a cell of the second RAN and receive pilot signals from a network node of the first RAN. The UE may measure a cell selection measurement based on receiving the pilot signals, and the UE may reduce the cell selection measurement by the offset while the offset validity timer is not expired.

Referring to FIGS. 4-5, the UE 404 may apply the connection failure offset 432 to reduce at least one of the NR2L or L2NR cell (re)selection measurements 566 associated with the network node 402 of a first RAN after detecting the connection establishment failures 428a-428b in the first RAN and establishing a connection in a second RAN with the other node 406.

At 618, the UE may reattempt a connection establishment procedure after applying the set of preconfigured values respectively associated with the set of connection establishment failure control parameters. For example, the UE may (re)select another cell and the UE may transmit a connection request message to the network node of the selected cell.

Referring to FIGS. 4-5, the UE 404 may reattempt a connection establishment procedure after applying the default connEstFailureControl values 522 respectively associated with the set of connection establishment failure control parameters.

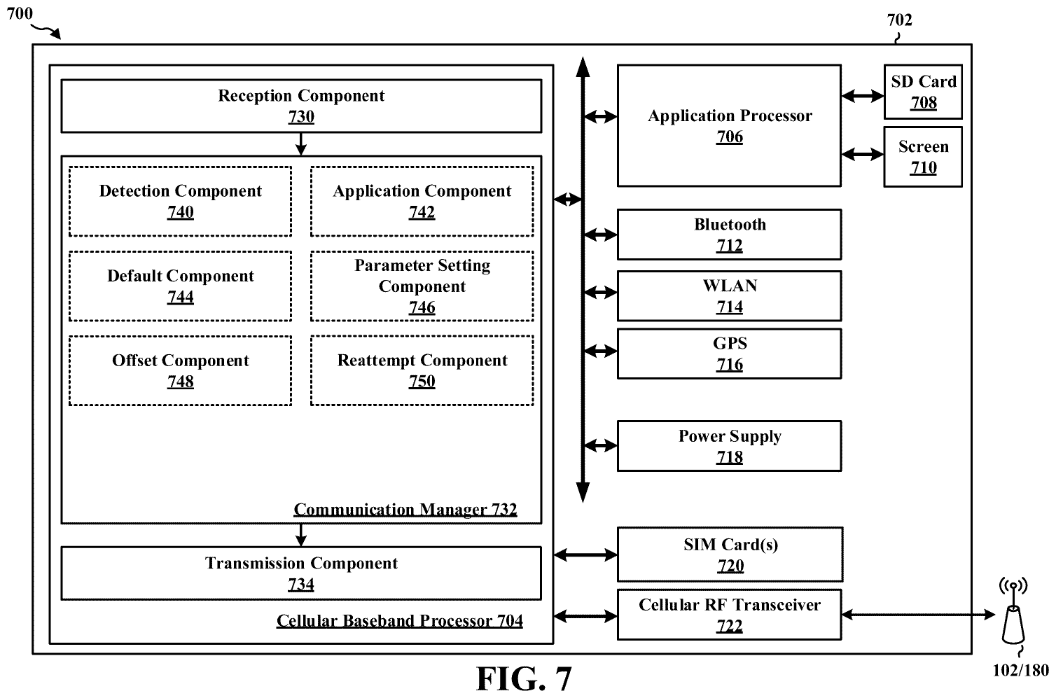

FIG. 7 is a diagram 700 illustrating an example of a hardware implementation for an apparatus 702. The apparatus 702 may be a UE or similar device, or the apparatus 702 may be a component of a UE or similar device. The apparatus 702 may include a cellular baseband processor 704 (also referred to as a modem) and/or a cellular RF transceiver 722, which may be coupled together and/or integrated into the same package, component, circuit, chip, and/or other circuitry.

In some aspects, the apparatus 702 may accept or may include one or more subscriber identity modules (SIM) cards 720, which may include one or more integrated circuits, chips, or similar circuitry, and which may be removable or embedded. The one or more SIM cards 720 may carry identification and/or authentication information, such as an international mobile subscriber identity (IMSI) and/or IMSI-related key(s). Further, the apparatus 702 may include one or more of an application processor 706 coupled to a secure digital (SD) card 708 and a screen 710, a Bluetooth module 712, a wireless local area network (WLAN) module 714, a Global Positioning System (GPS) module 716, and/or a power supply 718.

The cellular baseband processor 704 communicates through the cellular RF transceiver 722 with the UE 104 and/or network node 102/180. The cellular baseband processor 704 may include a computer-readable medium/memory. The computer-readable medium/memory may be non-transitory in some aspects. The cellular baseband processor 704 is responsible for general processing, including the execution of software stored on the computer-readable medium/memory. The software, when executed by the cellular baseband processor 704, causes the cellular baseband processor 704 to perform the various functions described supra. The computer-readable medium/memory may also be used for storing data that is manipulated by the cellular baseband processor 704 when executing software. The cellular baseband processor 704 further includes a reception component 730, a communication manager 732, and a transmission component 734. The communication manager 732 includes the one or more illustrated components. The components within the communication manager 732 may be stored in the computer-readable medium/memory and/or configured as hardware within the cellular baseband processor 704.

In the context of FIG. 3, the cellular baseband processor 704 may be a component of the UE 350 and may include the memory 360 and/or at least one of the TX processor 368, the RX processor 356, and/or the controller/processor 359. In one configuration, the apparatus 702 may be a modem chip and/or may be implemented as the baseband processor 704, while in another configuration, the apparatus 702 may be the entire UE (e.g., the UE 350 of FIG. 3) and may include some or all of the abovementioned components, circuits, chips, and/or other circuitry illustrated in the context of the apparatus 702. In one configuration, the cellular RF transceiver 722 may be implemented as at least one of the transmitter 354TX and/or the receiver 354RX.

The reception component 730 may be configured to receive signaling on a wireless channel, such as signaling from a network node 102/180. The transmission component 734 may be configured to transmit signaling on a wireless channel, such as signaling to a network node 102/180. The communication manager 732 may coordinate or manage some or all wireless communications by the apparatus 702, including across the reception component 730 and the transmission component 734.

The reception component 730 may provide some or all data and/or control information included in received signaling to the communication manager 732, and the communication manager 732 may generate and provide some or all of the data and/or control information to be included in transmitted signaling to the transmission component 734. The communication manager 732 may include the various illustrated components, including one or more components configured to process received data and/or control information, and/or one or more components configured to generate data and/or control information for transmission.

The communication manager 732 may include a detection component 740, an application component 742, a default component 744, a parameter setting component 746, an offset component 748, and/or a reattempt component 750.

The detection component 740 may be configured to detect a connection establishment failure associated with a network node, e.g., as described in connection with 602 of FIG. 6. For example, the transmission component 734 may transmit a connection establishment request message to a network node 102/180 and trigger a T300 timer based thereon. The detection component 740 may determine if a connection setup message has been received before expiration of the T300 timer. If the detection component 740 does not receive a connection setup message from the selected cell before expiration of the T300 timer, then the detection component 740 may detect the connection establishment failure.

Further, the detection component 740 may be configured to determine whether a set of network-configured values for a connEstFailureControl IE has been received, e.g., as described in connection with 604 of FIG. 6. For example, the detection component 740 may receive a SIBI from the network node 102/180, and the detection component 740 may determine whether a connEstFailureControl IE in the SIB1 includes values for a set of parameters.

In some aspects, the application component 742 may apply a set of preconfigured values respectively associated with a set of connection establishment failure control parameters, e.g., as described in connection with 606 of FIG. 6. For example, the application component 742 may determine an offset parameter has not been configured by the network node 102/180, and the application component 742 may set the offset parameter to one of the preconfigured values. In another example, the application component 742 may determine an offset validity timer parameter has not been configured by the network, and the application component 742 may set the offset validity timer to another of the preconfigured values. In still another example, the application component 742 may determine a failure count threshold parameter has not been configured by the network node 102/180, and the application component 742 may set the failure count threshold to a third of the preconfigured values.

In some aspects, the default component 744 may default to the set of preconfigured values for the set of connection establishment failure control parameters, e.g., as described in connection with 608 of FIG. 6. For example, the default component 744 may determine that a set of parameters for connection establishment failure control are equal to null or are otherwise not configured, and based thereon, the default component 744 may set values of the null or non-configured parameters based on preconfigured values corresponding to the set of parameters.

The reattempt component 750 may be configured to reattempt a connection establishment procedure after applying the set of preconfigured values respectively associated with the set of connection establishment failure control parameters, e.g., as described in connection with 618 of FIG. 6. For example, the reattempt component 750 may (re)select another cell and the reattempt component 750 may transmit a connection request message to the network node 102/180 of the selected cell.

If some other aspects, the parameter setting component 746 may be configured to set a failure count threshold to a sum of a first network-configured value of the set of network-configured values and a first preconfigured value of a set of preconfigured values after a number of connection establishment failures is detected satisfying the failure count threshold set to the first network-configured value, e.g., as described in connection with 610 of FIG. 6. For example, the detection component 740 may determine a number of connection establishment failures that satisfy a failure count threshold set to a first network-configured value. If the detection component 740 determines that the number satisfies the threshold, then the parameter setting component 746 may add a first preconfigured value of a set of preconfigured values to a first network-configured value of a set of network-configured values, and the parameter setting component 746 may set the failure count threshold to the sum.

The parameter setting component 746 may be further configured to set an offset for a cell selection measurement to a sum of a second network-configured value of the set of network-configured values and a second preconfigured value of the set of preconfigured values after the number of connection establishment failures is detected satisfying the fail count threshold set to the first network-configured value, e.g., as described in connection with 612 of FIG. 6. For example, the detection component 740 may determine a number of connection establishment failures that satisfy a failure count threshold set to a first network-configured value. If the detection component 740 determines that the number satisfies the threshold, then the parameter setting component 746 may add a second preconfigured value of a set of preconfigured values to a second network-configured value of a set of network-configured values, and the parameter setting component 746 may set an offset to the sum.

The parameter setting component 746 may be further configured to set an offset validity timer to the sum of a third network-configured value of the set of network-configured values and a third preconfigured value of the set of preconfigured values after the number of connection establishment failures is detected satisfying the fail count threshold set to the first network-configured value, e.g., as described in connection with 614 of FIG. 6. For example, the detection component 740 may determine a number of connection establishment failures that satisfy a failure count threshold set to a first network-configured value. If the detection component 740 determines that the number satisfies the threshold, then the parameter setting component 746 may add a third preconfigured value of a set of preconfigured values to a third network-configured value of a set of network-configured values, and the parameter setting component 746 may set an offset validity timer to the sum.

The offset component 748 may be configured to offset a cell selection measurement associated with the network node 102/180 of a first RAN after detecting the connection establishment failure in the first RAN and establishing a connection in a second RAN, e.g., as described in connection with 616 of FIG. 6. For example, the apparatus 702 may camp on a cell of the second RAN and receive pilot signals from a network node 102/180 of the first RAN. The offset component 748 may measure a cell selection measurement based on receiving the pilot signals, and the offset component 748 may reduce the cell selection measurement by the offset while the offset validity timer is not expired.

The apparatus 702 may include additional components that perform some or all of the blocks, operations, signaling, etc. of the algorithm(s) in the aforementioned call flow diagram and/or flowchart of FIGS. 4 and 6. As such, some or all of the blocks, operations, signaling, etc. in the aforementioned call flow diagram and/or flowchart of FIGS. 4 and 6 may be performed by one or more components and the apparatus 702 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 702, and in particular the cellular baseband processor 704, includes means for detecting a connection establishment failure associated with a network node; and means for applying a set of preconfigured values respectively associated with a set of connection establishment failure control parameters when the connection establishment failure is detected.

In one configuration, the set of preconfigured values is not received from the network node.

In one configuration, the means for applying the set of preconfigured values respectively associated with the set of connection establishment failure control parameters is configured to default to the set of preconfigured values for the set of connection establishment failure control parameters when the connection establishment failure is detected and a set of network-configured values associated with the set of connection establishment failure control parameters has not been received from the network node.

In one configuration, the set of connection establishment failure control parameters comprises at least one of a failure count threshold, an offset for a cell selection measurement associated with the network node, or an offset validity timer associated with the offset for the cell selection measurement.

In one configuration, the apparatus 702, and in particular the cellular baseband processor 704, may further include means for receiving, from the network node, information indicating a set of network-configured values respectively associated with the set of connection establishment failure control parameters; and means for setting the failure count threshold to a sum of a first network-configured value of the set of network-configured values and a first preconfigured value of the set of preconfigured values after a number of connection establishment failures is detected satisfying the failure count threshold set to the first network-configured value.

In one configuration, the apparatus 702, and in particular the cellular baseband processor 704, may further include means for setting the offset for the cell selection measurement to a sum of a second network-configured value of the set of network-configured values and a second preconfigured value of the set of preconfigured values after the number of connection establishment failures is detected satisfying the failure count threshold set to the first network-configured value; and means for setting the offset validity timer to the sum of a third network-configured value of the set of network-configured values and a third preconfigured value of the set of preconfigured values after the number of connection establishment failures is detected satisfying the failure count threshold set to the first network-configured value.

In one configuration, the apparatus 702, and in particular the cellular baseband processor 704, may further include means for offsetting a cell selection measurement associated with the network node of a first RAN after detecting the connection establishment failure in the first RAN and establishing a connection in a second RAN.

In one configuration, the cell selection measurement is offset by a value that is preconfigured with respect to the connection in the second RAN.

In one configuration, the apparatus 702, and in particular the cellular baseband processor 704, may further include means for reattempting a connection establish procedure after applying the set of preconfigured values respectively associated with the set of connection establishment failure control parameters.

The aforementioned means may be one or more of the aforementioned components of the apparatus 702 configured to perform the functions recited by the aforementioned means. As described supra, the apparatus 702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following examples are illustrative only and may be combined with aspects of other embodiments or teachings described herein, without limitation.
Example 1 is an apparatus at a UE, the apparatus including a memory and at least one processor coupled to the memory and configured to: detect a connection establishment failure associated with a network node; and apply a set of preconfigured values respectively associated with a set of connection establishment failure control parameters when the connection establishment failure is detected.
Example 2 may include the apparatus of Example 1, and the set of preconfigured values is not received from the network node.
Example 3 may include the apparatus of Examples 1 or 2, and application of the set of preconfigured values respectively associated with the set of connection establishment failure control parameters comprises to default to the set of preconfigured values for the set of connection establishment failure control parameters when the connection establishment failure is detected and a set of network-configured values associated with the set of connection establishment failure control parameters has not been received from the network node.
Example 4 may include the apparatus of any of Examples 1 through 3, and the set of connection establishment failure control parameters comprises at least one of a failure count threshold, an offset for a cell selection measurement associated with the network node, or an offset validity timer associated with the offset for the cell selection measurement.
Example 5 may include apparatus of Example 4, and the at least one processor may be further configured to: receive, from the network node, information indicating a set of network-configured values respectively associated with the set of connection establishment failure control parameters; and set the failure count threshold to a sum of a first network-configured value of the set of network-configured values and a first preconfigured value of the set of preconfigured values after a number of connection establishment failures is detected satisfying the failure count threshold set to the first network-configured value.
Example 6 may include of Example 5, and the at least one processor may be further configured to: set the offset for the cell selection measurement to a sum of a second network-configured value of the set of network-configured values and a second preconfigured value of the set of preconfigured values after the number of connection establishment failures is detected satisfying the failure count threshold set to the first network-configured value; and set the offset validity timer to the sum of a third network-configured value of the set of network-configured values and a third preconfigured value of the set of preconfigured values after the number of connection establishment failures is detected satisfying the failure count threshold set to the first network-configured value.
Example 7 may include the apparatus of any of Examples 4 through 6, and the at least one processor may be further configured to: offset a cell selection measurement associated with the network node of a first RAN after detection of the connection establishment failure in the first RAN and establishment of a connection in a second RAN.
Example 8 may include the apparatus of Example 7, and the cell selection measurement is offset by a value that is preconfigured with respect to the connection in the second RAN.
Example 9 may include the apparatus of any of Examples 1 through 8, and the at least one processor may be further configured to reattempt a connection establish procedure after application of the set of preconfigured values respectively associated with the set of connection establishment failure control parameters.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
detecting a connection establishment failure associated with a network node; and
applying a set of preconfigured values respectively associated with a set of connection establishment failure control parameters when the connection establishment failure is detected.

2. The method of claim 1, wherein the set of preconfigured values is not received from the network node.

3. The method of claim 1, wherein applying the set of preconfigured values respectively associated with the set of connection establishment failure control parameters comprises:
defaulting to the set of preconfigured values for the set of connection establishment failure control parameters when the connection establishment failure is detected and a set of network-configured values associated with the set of connection establishment failure control parameters has not been received from the network node.

4. The method of claim 1, wherein the set of connection establishment failure control parameters comprises at least one of a failure count threshold, an offset for a cell selection measurement associated with the network node, or an offset validity timer associated with the offset for the cell selection measurement.

5. The method of claim 4, further comprising:
receiving, from the network node, information indicating a set of network-configured values respectively associated with the set of connection establishment failure control parameters; and
setting the failure count threshold to a sum of a first network-configured value of the set of network-configured values and a first preconfigured value of the set of preconfigured values after a number of connection establishment failures is detected satisfying the failure count threshold set to the first network-configured value.

6. The method of claim 5, further comprising:
setting the offset for the cell selection measurement to a sum of a second network-configured value of the set of network-configured values and a second preconfigured value of the set of preconfigured values after the number of connection establishment failures is detected satisfying the failure count threshold set to the first network-configured value; and
setting the offset validity timer to the sum of a third network-configured value of the set of network-configured values and a third preconfigured value of the set of preconfigured values after the number of connection establishment failures is detected satisfying the failure count threshold set to the first network-configured value.

7. The method of claim 4, further comprising:
offsetting a cell selection measurement associated with the network node of a first radio access network (RAN) after detecting the connection establishment failure in the first RAN and establishing a connection in a second RAN.

8. The method of claim 7, wherein the cell selection measurement is offset by a value that is preconfigured with respect to the connection in the second RAN.

9. The method of claim 1, further comprising:
reattempting a connection establish procedure after applying the set of preconfigured values respectively associated with the set of connection establishment failure control parameters.

10. An apparatus for wireless communication at a user equipment (UE), comprising:
a memory; and
at least one processor coupled to the memory and configured to:
detect a connection establishment failure associated with a network node; and
apply a set of preconfigured values respectively associated with a set of connection establishment failure control parameters when the connection establishment failure is detected.

11. The apparatus of claim 10, wherein the set of preconfigured values is not received from the network node.

12. The apparatus of claim 10, wherein application of the set of preconfigured values respectively associated with the set of connection establishment failure control parameters comprises to:
default to the set of preconfigured values for the set of connection establishment failure control parameters when the connection establishment failure is detected and a set of network-configured values associated with the set of connection establishment failure control parameters has not been received from the network node.

13. The apparatus of claim 10, wherein the set of connection establishment failure control parameters comprises at least one of a failure count threshold, an offset for a cell selection measurement associated with the network node, or an offset validity timer associated with the offset for the cell selection measurement.

14. The apparatus of claim 13, wherein the at least one processor is further configured to:
receive, from the network node, information indicating a set of network-configured values respectively associated with the set of connection establishment failure control parameters; and
set the failure count threshold to a sum of a first network-configured value of the set of network-configured values and a first preconfigured value of the set of preconfigured values after a number of connection establishment failures is detected satisfying the failure count threshold set to the first network-configured value.

15. The apparatus of claim 14, wherein the at least one processor is further configured to:
set the offset for the cell selection measurement to a sum of a second network-configured value of the set of network-configured values and a second preconfigured value of the set of preconfigured values after the number of connection establishment failures is detected satisfying the failure count threshold set to the first network-configured value; and
set the offset validity timer to the sum of a third network-configured value of the set of network-configured values and a third preconfigured value of the set of preconfigured values after the number of connection establishment failures is detected satisfying the failure count threshold set to the first network-configured value.

16. The apparatus of claim 13, wherein the at least one processor is further configured to:
offset a cell selection measurement associated with the network node of a first radio access network (RAN) after detecting the connection establishment failure in the first RAN and establishing a connection in a second RAN.

17. The apparatus of claim 16, wherein the cell selection measurement is offset by a value that is preconfigured with respect to the connection in the second RAN.

18. The apparatus of claim 10, wherein the at least one processor is further configured to:
reattempt a connection establish procedure after applying the set of preconfigured values respectively associated with the set of connection establishment failure control parameters.

19. An apparatus for wireless communication at a user equipment (UE), comprising:
means for detecting a connection establishment failure associated with a network node; and
means for applying a set of preconfigured values respectively associated with a set of connection establishment failure control parameters when the connection establishment failure is detected.

20. The apparatus of claim 19, wherein the set of preconfigured values is not received from the network node.

21. The apparatus of claim 19, wherein the means for applying the set of preconfigured values respectively associated with the set of connection establishment failure control parameters is configured to:
default to the set of preconfigured values for the set of connection establishment failure control parameters when the connection establishment failure is detected and a set of network-configured values associated with the set of connection establishment failure control parameters has not been received from the network node.

22. The apparatus of claim 19, wherein the set of connection establishment failure control parameters comprises at least one of a failure count threshold, an offset for a cell selection measurement associated with the network node, or an offset validity timer associated with the offset for the cell selection measurement.

23. The apparatus of claim 22, further comprising:
means for receiving, from the network node, information indicating a set of network-configured values respectively associated with the set of connection establishment failure control parameters; and
means for setting the failure count threshold to a sum of a first network-configured value of the set of network-configured values and a first preconfigured value of the set of preconfigured values after a number of connection establishment failures is detected satisfying the failure count threshold set to the first network-configured value.

24. The apparatus of claim 23, further comprising:
means for setting the offset for the cell selection measurement to a sum of a second network-configured value of the set of network-configured values and a second preconfigured value of the set of preconfigured values after the number of connection establishment failures is detected satisfying the failure count threshold set to the first network-configured value; and
means for setting the offset validity timer to the sum of a third network-configured value of the set of network-configured values and a third preconfigured value of the set of preconfigured values after the number of connection establishment failures is detected satisfying the failure count threshold set to the first network-configured value.

25. The apparatus of claim 22, further comprising:
means for offsetting a cell selection measurement associated with the network node of a first radio access network (RAN) after detecting the connection establishment failure in the first RAN and establishing a connection in a second RAN.

26. The apparatus of claim 25, wherein the cell selection measurement is offset by a value that is preconfigured with respect to the connection in the second RAN.

27. The apparatus of claim 19, further comprising:
means for reattempting a connection establish procedure after applying the set of preconfigured values respectively associated with the set of connection establishment failure control parameters.

28. A computer-readable medium storing computer-executable code for wireless communication at a user equipment (UE), the code when executed by a processor cause the processor to:
detect a connection establishment failure associated with a network node; and
apply a set of preconfigured values respectively associated with a set of connection establishment failure control parameters when the connection establishment failure is detected.

29. The computer-readable medium of claim 28, wherein the set of preconfigured values is not received from the network node. 30 The computer-readable medium of claim 28, wherein application of the set of preconfigured values respectively associated with the set of connection establishment failure control parameters comprises to:
default to the set of preconfigured values for the set of connection establishment failure control parameters when the connection establishment failure is detected and a set of network-configured values associated with the set of connection establishment failure control parameters has not been received from the network node.
